(19) United States
(12) Patent Application Publication
(10) Pub. No.: US 2015/0194702 A1
(43) Pub. Date: Jul. 9, 2015

(54) NON-AQUEOUS ELECTROLYTE SECONDARY BATTERY AND METHOD FOR MANUFACTURING NON-AQUEOUS ELECTROLYTE SECONDARY BATTERY

(71) Applicant: TOYOTA JIDOSHA KABUSHIKI KAISHA, Toyota-shi, Aichi (JP)

(72) Inventors: Takashi Tokunaga, Toyota-shi (JP); Tetsuya Waseda, Okazaki-shi (JP)

(21) Appl. No.: 14/410,658

(22) PCT Filed: Jun. 24, 2013
(86) PCT No.: PCT/JP2013/067221

§ 371 Date: Dec. 23, 2014

(30) Foreign Application Priority Data
Jun. 29, 2012 (JP) 2012-147896

(51) Int. Cl. H01M 10/0567; H01M 10/04

(52) U.S. Cl. CPC H01M 10/0567; H01M 10/0431

(57) ABSTRACT

Provided is a non-aqueous electrolyte secondary battery capable of satisfying, in a well-balanced manner, standards for input characteristics, safety, and storage durability. A lithium-ion secondary battery includes a wound electrode body formed by winding a positive electrode and a negative electrode with a separator interposed therebetween, and an electrolyte solution provided between the positive electrode and the negative electrode. A negative electrode mixture layer containing a negative electrode active material is formed on the surface of the negative electrode. The average particle diameter of the negative electrode active material is not smaller than 5 μm and not larger than 20 μm. The fine powder amount which is the cumulative frequency of the negative electrode active material having a particle diameter not larger than 3 μm is not less than 10% and not more than 50%. The electrolyte solution contains not less than 0.1 M and not more than 0.4 M of an oxalatoborate-type compound and not less than 0.06 M of a difluorophosphate compound.

### TECHNICAL FIELD

The present invention technically relates to a non-aqueous electrolyte secondary battery and a method for manufacturing a non-aqueous electrolyte secondary battery.

### BACKGROUND ART

As a non-aqueous electrolyte secondary battery, a lithium-ion secondary battery, for example, is well known. In recent years, there is an increasing importance of a lithium-ion secondary battery as a power source for being mounted on vehicles such as a hybrid vehicle and an electric vehicle, or as a power source for being mounted on electric products such as a personal computer and a mobile device.

In a non-aqueous electrolyte secondary battery such as a lithium-ion secondary battery, an electrolyte solution is housed inside a battery case so as to be interposed between a positive electrode and a negative electrode. The electrolyte solution is a solution with an electric conductivity prepared by dissolving a lithium salt such as LiPF₆, which is an electrolyte, into a solvent such as ethylene carbonate (EC).

In the non-aqueous electrolyte secondary battery such as a lithium-ion secondary battery, part of the non-aqueous electrolyte and the solvent is decomposed during charging the battery, and thereby a film (Solid Electrolyte Interphase film; hereafter referred to as “SEI film”) is formed on the surface of a negative electrode active material. By repetition of charging and discharging the battery, such a SEI film is excessively formed to increase in thickness. This causes increase in the resistance of the negative electrode, leading to decrease in the battery performance.

Various kinds of additives are known as means for solving such a problem. Patent Literatures 1 and 2 disclose a non-aqueous electrolyte containing an oxalatoborate-type compound (e.g., lithium bis(oxalato)borate).

An oxalatoborate-type compound is decomposed at an initial charge of the secondary battery to form a SEI film on the negative electrode active material. This film is hardly formed excessively in association with the charge and the discharge. Therefore, the increase in the thickness of the film is suppressed, and the increase in the resistance of the negative electrode is suppressed.

However, the SEI film formed by an oxalatoborate-type compound has a high resistance in itself, thereby disadvantageously giving a larger resistance of the initial negative electrode, that is, a larger initial input resistance in the above-mentioned battery, than that of a SEI film which does not contain the compound.

On the other hand, in a non-aqueous electrolyte secondary battery such as a lithium-ion secondary battery, natural graphite, artificial graphite, graphitized mesophase carbon particles, graphitized mesophase carbon fibers, and the like are used as the negative electrode active material.

With respect to the above-mentioned carbon materials, if the particle diameter is increased, the initial efficiency improves, but the electric conductivity of the mixture layer deteriorates. In particular, when a lithium-ion secondary battery is used for a hybrid vehicle or the like, there is a problem in that the input characteristics for satisfying the vehicle performance cannot be ensured. Moreover, if the particle diameter is reduced, the reaction area increases to improve the input characteristics, but the reaction between the carbon materials and the electrolyte solution becomes excessive, thereby the cycle characteristics deteriorating.

In order to solve the above-mentioned problems, Patent Literature 3 discloses that the filling property of a negative electrode plate is improved by mixing a larger-particle carbon material and a smaller-particle carbon material having predetermined particle diameters and BET specific surface areas at a predetermined ratio, thus enabling to produce a negative electrode plate with excellent initial efficiency and cycle characteristics.

However, though a negative electrode plate with improved input characteristics can be produced by mixing the larger-particle-diameter and smaller-particle-diameter carbon materials, the reaction area decreases as compared with a negative electrode plate in which only the smaller-particle-diameter carbon material is used. Therefore, the input characteristics required for the hybrid vehicle cannot be satisfied. Moreover, it has been found out that, by using the smaller-particle-diameter carbon material, the reaction between the carbon materials and the electrolyte solution becomes excessive, thereby leading to increase in the heat-generating reaction at the time of excessive charging.

### CITATION LIST

### Patent Literature

Patent Literature 1: JP 2011-34893 A

Patent Literature 2: JP 2007-165125 A

Patent Literature 3: JP 2010-176973 A

### SUMMARY OF INVENTION

### Problem to be Solved by the Invention

The objective of the present invention is to provide a non-aqueous electrolyte secondary battery capable of satisfying, in a well-balanced manner, standards for input characteristics, storage durability and safety, and a method for manufacturing a non-aqueous electrolyte secondary battery.

### Means for Solving the Problem

The problems to be solved by the present invention are as described above, and means for solving the problems is described below.

A first aspect of the present invention is a non-aqueous electrolyte secondary battery including a wound electrode body formed by winding a positive electrode and a negative electrode with a separator interposed therebetween, and an electrolyte solution provided between the positive electrode and the negative electrode. A negative electrode mixture layer containing a negative electrode active material is formed on a surface of the negative electrode. An average particle diameter of the negative electrode active material is not smaller than 5 μm and not larger than 20 μm. A fine powder amount which is the cumulative frequency of the negative electrode active material having a particle diameter not larger than 3 μm is not less than 10% and not more than 50%. The electrolyte solution contains not less than 0.1 M and not more than 0.4 M of an oxalatoborate-type compound, and not less than 0.06 M of a difluorophosphate compound.

A second aspect of the present invention is a method for manufacturing a non-aqueous electrolyte secondary battery having a wound electrode body formed by winding a positive electrode and a negative electrode with a separator interposed therebetween, and an electrolyte solution provided between the positive electrode and the negative electrode. The method including a step for forming a negative electrode mixture layer containing a negative electrode active material on a surface of the negative electrode, a step for adjusting an average particle diameter of the negative electrode active material to not smaller than 5 μm and not larger than 20 μm, a step for adjusting a fine powder amount which is the cumulative frequency of the negative electrode active material having a particle diameter not larger than 3 μm to not less than 10% and not more than 50%, and a step for adding not less than 0.1 M and not more than 0.4 M of an oxalatoborate-type compound, and not less than 0.06 M of a difluorophosphate compound into the electrolyte solution.

### Effects of the Invention

The present invention makes it possible to satisfy, in a well-balanced manner, standards for input characteristics, storage durability and safety.

### BRIEF DESCRIPTION OF DRAWINGS

FIG. 1 is a schematic view illustrating an overall configuration of a lithium-ion secondary battery.

FIG. 2 is a schematic cross-sectional view of an electrode body.

FIG. 3 is a graph showing a fine powder amount.

FIG. 4 is a graph showing characteristics of fine powder amount and LiBOB amount.

FIG. 5 is a graph showing characteristics of P1 amount.

### DESCRIPTION OF EMBODIMENTS

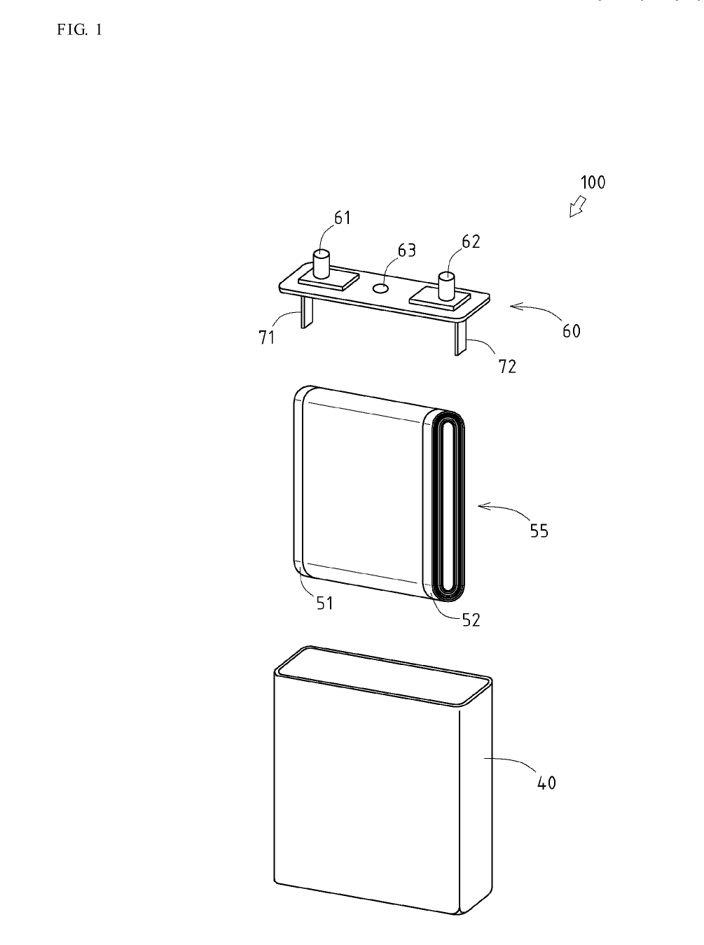

With reference to FIG. 1, a configuration of a lithium-ion secondary battery 100 is described.

In FIG. 1, for convenience, a battery case 40, a wound electrode body 55, and a lid 60 are separated from each other to be schematically shown.

The lithium-ion secondary battery 100 is one embodiment of a non-aqueous electrolyte secondary battery according to the present invention. The lithium-ion secondary battery 100 includes the battery case 40, the wound electrode body 55, and the lid 60.

The battery case 40 is formed as a box body having a substantially rectangular parallelepiped shape with an opened upper surface. The opened upper surface of the battery case 40 is sealed with the lid 60. Moreover, the wound electrode body 55 is housed together with an electrolyte solution inside the battery case 40.

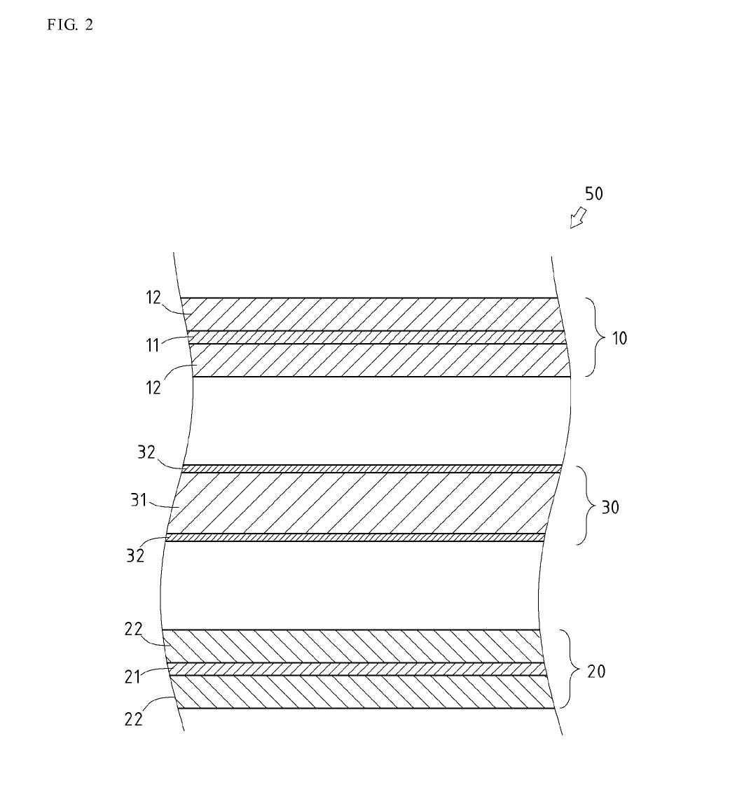

The wound electrode body 55 is configured in such a manner that an electrode body 50 (See FIG. 2) made by laminating a negative electrode 20, a positive electrode 10, and a separator 30 is wound and formed into a flat shape so that the separator 30 is interposed between the negative electrode 20 and the positive electrode 10.

The wound electrode body 55 is housed in the battery case 40 so that the axial direction of the wound electrode body 55 is perpendicular to the direction in which the opening of the battery case 40 is sealed by the lid 60.

A positive electrode collector 51 (one in which only a later-described collecting foil 11 is wound) is exposed at an end on one side of the axial direction of the wound electrode body 55. On the other hand, a negative electrode collector 52 (one in which only a later-described collecting foil 21 is wound) is exposed at an end on the other side of the axial direction of the wound electrode body 55.

The lid 60 seals the upper surface of the battery case 40. Specifically, the lid 60 is joined to the upper surface of the battery case 40 by laser welding to seal the upper surface of the battery case 40. In other words, in the lithium-ion secondary battery 100, the lid 60 is joined to the opening of the battery case 40 by laser welding, and thereby the opening of the battery case 40 is sealed.

A positive electrode collecting terminal 61 and a negative electrode collecting terminal 62 are provided on the upper surface of the lid 60. A leg part 71 extending downwards is formed in the positive electrode collecting terminal 61. Similarly, a leg part 72 extending downwards is formed in the negative electrode collecting terminal 62.

A pouring hole 63 is formed in the upper surface of the lid 60. The wound electrode body 55 is housed in the battery case 40 in a state of being joined to the lid 60 provided with the positive electrode collecting terminal 61 and the negative electrode collecting terminal 62. The lid 60 is joined to the upper surface of the battery case 40 by laser welding, and then the electrolyte solution is poured through the pouring hole 63. In this manner, the battery is completed.

With reference to FIG. 2, the electrode body 50 is described.

In FIG. 2, a part of the electrode body 50 is schematically shown in a cross-sectional view.

The electrode body 50 is formed by laminating the negative electrode 20, the positive electrode 10, and the separator 30 so that the separator 30 is interposed between the negative electrode 20 and the positive electrode 10.

The positive electrode 10 has the collecting foil 11 and a positive electrode mixture layer 12. The positive electrode mixture layer 12 is formed on both the surfaces of the collecting foil 11. The positive electrode mixture layer 12 is formed in such a manner that a positive electrode mixture, which is prepared by kneading a positive electrode active material (e.g., Li_{1.14}Ni_{0.34}Co_{0.33}Mn_{0.33}O₂), a conductive agent (e.g., acetylene black (AB)), and a binding agent (e.g., polyvinylidene fluoride (PVDF)) at a predetermined ratio together with a solvent (e.g., N-methyl-2-pyrrolidone (NMP)), is applied onto the collecting foil 11, dried, and pressed.

### [Positive Electrode Active Material]

The positive electrode mixture forming the positive electrode mixture layer 12 of the positive electrode 10 contains a positive electrode active material that intercalates and deintercalates lithium ions. Typical examples of the positive electrode active material include a lithium transition metal composite oxide having a layered crystal structure (typically, a layered rock salt type structure belonging to the hexagonal system) (e.g., LiNiO₂, LiCoO₂, or LiNiCoMnO₂, which may partly contain an additive element such as W, Cr, Mo, Zr, Mg, Ca, Na, Fe, Zn, Si, Sn, or Al), a lithium transition metal composite oxide having a spinel type crystal structure (e.g., LiMn₂O₄, or LiNiMn₂O₄), and a lithium transition metal composite oxide having an olivine type crystal structure (e.g., LiFePO₄).

### [Positive Electrode Mixture]

In addition to the positive electrode active material, additive materials such as a conductive material and a binding material (binder) are added into the positive electrode mixture as necessary.

The conductive material may contain one or mixture of two of a conductive substance such as carbon powder (carbon black such as acetylene black (AB), furnace black or Ketjen black, or graphite powder) or a conductive carbon fiber.

The binding material may be one of various polymer materials. For example, in the case where a solvent mainly containing water is used as the dispersion medium, a polymer material capable of being dissolved or dispersed into water can be preferably used as the binding material. Examples of the water-soluble or water-dispersible polymer materials include cellulose-based polymers such as carboxymethyl cellulose (CMC), fluororesins such as polytetrafluoroethylene (PTFE), polyvinyl alcohol (PVA), vinyl acetate polymer, and rubbers such as styrene-butadiene rubber (SBR). In the case where a solvent mainly containing an organic solvent such as N-methyl-2-pyrrolidone (NMP) is used as the dispersion medium, a polymer material such as polyvinylidene fluoride (PVDF), or polyalkylene oxide such as polyethylene oxide (PEO) may be used as the binding material. The above-mentioned binding material may be used as a combination of two or more kinds, and may also be used as an additive material such as a thickening material.

The constituent component ratios of the positive electrode active material, the conductive material, and the binding material in the positive electrode mixture are each determined from the viewpoint of the retaining property of the positive electrode mixture layer 12 on the collecting foil 11 and the battery performance. Typically, the positive electrode mixture preferably contains, for example, approximately 75 to 95 wt % of the positive electrode active material, 3 to 18 wt % of the conductive material, and 2 to 7 wt % of the binding material.

### [Method for Producing Positive Electrode]

First, a positive electrode active material, a conductive material, a binding material and the like are mixed together with a suitable solvent to prepare a positive electrode mixture. This mixing preparation may be carried out, for example, by using a kneader such as a planetary mixer, a homodisper, a Clearmix (registered trademark), or a Filmix (registered trademark).

The positive electrode mixture prepared in this manner is applied onto the collecting foil 11 by means of an applying apparatus such as a slit coater, a die coater, a gravure coater, or a Comma Coater (registered trademark), and is pressed after the solvent is volatilized by drying. Through the above-mentioned steps, the positive electrode 10 is obtained in which the positive electrode mixture layer 12 is formed on the collecting foil 11.

The coating amount (mg/cm²) of the positive electrode mixture onto the collecting foil 11 per unit area is preferably 6 mg/cm² to 20 mg/cm² per one surface of the collecting foil 11 from the viewpoint of not only the energy but also the electron conductivity and the lithium-ion diffusibility in the positive electrode mixture layer 12 for the purpose of high output in a hybrid vehicle and the like. Due to similar reasons, the density of the positive electrode mixture layer 12 is preferably 1.7 g/cm³ to 2.8 g/cm³.

A conductive member made of a metal having a satisfactory electric conductivity is preferably used for the collecting foil 11, and aluminum or an alloy containing aluminum as a major component may be used. The shape and thickness of the collecting foil 11 are not particularly limited. The shape may be a sheet shape, a foil shape, a mesh shape or the like, and the thickness may be, for example, 10 μm to 30 μm.

The negative electrode 20 has the collecting foil 21 and a negative electrode mixture layer 22. The negative electrode mixture layer 22 is formed on both the surfaces of the collecting foil 21. The negative electrode mixture layer 22 is formed in such a manner that a negative electrode mixture, which is prepared by kneading a negative electrode active material, a thickening agent (e.g., carboxymethyl cellulose (CMC)) and a binding agent (e.g., styrene-butadiene rubber (SBR)) at a predetermined ratio together with water, is applied onto the collecting foil 21, dried, and pressed. The negative electrode active material in the present embodiment is prepared in such a manner that spheroidized natural graphite coated with low-crystalline carbon is mixed and impregnated with a predetermined rate of pitch, and fired under an inert atmosphere.

### [Negative Electrode Active Material]

The negative electrode mixture forming the negative electrode mixture layer 22 of the negative electrode 20 contains a negative electrode active material that intercalates and deintercalates lithium ions. The negative electrode active material may be one of various materials, for example, oxide such as lithium titanate, single bodies, alloys, and compounds of silicon materials and tin materials, and composite materials using the above-mentioned materials in combination. However, a carbon material containing graphite as a major component is most preferably used as the negative electrode active material by summing up the viewpoints of costs, productivity, energy density, and long-term reliability. In particular, for the purpose of high output in a hybrid vehicle and the like, a composite material in which the surface of particles containing graphite as a core is coated with amorphous carbon, which can improve the property of intercalation and deintercalation of lithium ions, is more suitable. Moreover, carbon materials other than graphite, such as hardly graphitizable amorphous carbon and easily graphitizable amorphous carbon, may be mixed as well.

Among the above-mentioned graphites, spheroidized natural graphite, for example, may be used as the negative electrode active material. The spheroidizing process is typically carried out in such a manner that, by applying a stress onto a graphite crystal basal surface (AB surface) of squamous graphite particles or the like in the parallel direction through a mechanical treatment, the graphite crystal basal surface is spheroidized in a concentric manner or while taking a folded structure in a folded state. By performing grinding or milling and sieving or classification, spheroidized natural graphite having an intended particle size can be obtained. The classification may be carried out by a method such as air classification, wet classification, or specific gravity classification, but use of an air classification machine is preferable. In this case, the spheroidized natural graphite can be adjusted to have an intended particle size distribution by controlling the air amount and the air speed.

A graphitizing treatment can be carried out by adding cokes, pitch, thermosetting resin and the like to the above-mentioned spheroidized natural graphite and by performing a heat treatment. By performing grinding or milling and sieving or classification on this graphitized product, an intended particle size can be obtained. The classification can be carried out by a method such as air classification, wet classification, or specific gravity classification, but use of an air classification machine is preferable. In this case, the graphitized product can be adjusted to have an intended particle size distribution by controlling the air amount and the air speed.

The average particle diameter of the negative electrode active material is preferably within a range of 5 μm to 20 μm.

The BET specific surface area of the negative electrode active material is preferably within a range of, for example, 1.0 to 10.0 m²/g, more preferably within a range of 3.0 to 6.0 m²/g.

### [Negative Electrode Mixture]

In addition to the negative electrode active material, additive materials such as a thickening material and a binding material are added into the negative electrode mixture.

The thickening material and the binding material may be, for example, one of various polymer materials. For example, in the case where a solvent mainly containing water is used as the dispersion medium, a polymer material capable of being dissolved or dispersed into water may be preferably used as the thickening material and the binding material. Examples of the water-soluble or water-dispersible polymer materials include cellulose-based polymers such as carboxymethyl cellulose (CMC), fluororesins such as polytetrafluoroethylene (PTFE), polyvinyl alcohol (PVA), vinyl acetate polymer, and rubbers such as styrene-butadiene rubber (SBR). In the case where a solvent mainly containing an organic solvent such as N-methyl-2-pyrrolidone (NMP) is used as the dispersion medium, a polymer material such as polyvinylidene fluoride (PVDF) or polyalkylene oxide represented by polyethylene oxide (PEO) or the like can be used as the thickening material and the binding material. The above-mentioned thickening material and binding material may be used each as a combination of two or more kinds of materials.

The ratio of the constituent component of each of the negative electrode active material, the thickening material and the binding material in the negative electrode mixture is determined from the viewpoint of the retaining property of the negative electrode mixture layer 22 on the collecting foil 21 and the battery performance. Typically, the negative electrode mixture preferably contains, for example, approximately 90 to 99 wt % of the negative electrode active material, and 1 to 10 wt % of the thickening material and the binding material.

### [Method for Preparing Negative Electrode]

First, a negative electrode active material, a thickening material, a binding material and the like are mixed together with a suitable solvent to prepare a negative electrode mixture. This mixing preparation may be carried out, for example, by using a kneader such as a planetary mixer, a homodisper, a Clearmix (registered trademark), or a Filmix (registered trademark).

The negative electrode mixture prepared in this manner is applied onto the collecting foil 21 by means of an applying apparatus such as a slit coater, a die coater, a gravure coater, or a Comma Coater (registered trademark), and is pressed after the solvent is volatilized by drying. Through the above-mentioned steps, the negative electrode 20 is obtained in which the negative electrode mixture layer 22 is formed on the collecting foil 21.

The coating amount (mg/cm²) of the negative electrode mixture onto the collecting foil 21 per unit area is preferably 3 mg/cm² to 10 mg/cm² per one surface of the collecting foil 21 from the viewpoint of not only the energy but also the electron conductivity and the lithium-ion diffusibility in the negative electrode mixture layer 22 for the purpose of high output in a hybrid vehicle and the like. Due to similar reasons, the density of the negative electrode mixture layer 22 is preferably 1.0 g/cm³ to 1.4 g/cm³.

A conductive member made of a metal having a satisfactory electric conductivity is preferably used for the collecting foil 21, and copper or an alloy containing copper as a major component can be used. The shape and thickness of the collecting foil 21 are not particularly limited. The shape may be a sheet shape, a foil shape, a mesh shape or the like, and the thickness may be, for example, 5 μm to 20 μm.

The separator 30 has a base material layer 31 and a Heat Resistance layer (HRL) 32 as a heat-resistant layer. The HRL 32 is formed on both the surfaces of the base material layer 31. The HRL 32 in the present embodiment is formed of porous inorganic fillers.

### [Separator]

The separator 30 insulates the positive electrode mixture layer 12 from the negative electrode mixture layer 22. The separator 30 has a mechanism of permitting movement of the electrolyte at the time of normal use and shutting out the movement of the electrolyte if the temperature inside the battery becomes high (e.g., 130° C. or higher) by abnormal phenomenon. As the base material layer 31 of the separator 30, a porous resin may be used. For example, a polyolefin-based resin such as polyethylene (PE) or polypropylene (PP) may suitably be used as the base material layer 31. In particular, it is preferable to use a separator with a three-layer structure made by laminating PP, PE and PP in this order.

The base material layer 31 can be made porous, for example, by monoaxial stretching or biaxial stretching. In particular, when the base material layer 31 is monoaxially stretched in the longitudinal direction, the heat shrinkage in the width direction is small. Therefore, the base material layer 31 is suitable as one element of the separator 30 constituting the above-mentioned wound electrode body 55.

The thickness of the separator 30 is not particularly limited, but the thickness is preferably, for example, 10 μm to 30 μm, typically approximately 15 μm to 25 μm. When the thickness of the separator 30 is within the above-mentioned range, the ion permeability of the separator 30 is better, and breakage caused by shrinkage at high temperature and melting becomes less likely to be generated.

The HRL 32 is formed on at least one surface of the base material layer 31. If the temperature inside the battery becomes high, the HRL 32 minimizes the shrinkage of the base material layer 31 and further suppresses the short-circuit caused by direct contact between the positive electrode 10 and the negative electrode 20 even when the base material layer 31 is broken. The HRL 32 primarily consists of an inorganic filler such as an inorganic oxide such as alumina, boehmite, silica, titania, zirconia, calcia, or magnesia, an inorganic nitride, a carbonate, a sulfate, a fluoride, or a covalent crystal. Among these, it is preferable to use alumina, boehmite, silica, titania, zirconia, calcia, or magnesia due to the reason of being excellent in heat resistance and cycle characteristics, and it is particularly preferable to use boehmite or alumina.

The shape of the inorganic filler is not particularly limited, but is preferably particles formed in a plate (flake) from the viewpoint of suppressing the short-circuit between the positive electrode 10 and the negative electrode 20 when the base material layer 31 is broken. The average particle diameter of the inorganic filler is not particularly limited, but it is suitable to set the average particle diameter to be 0.1 μm to 5 μm from the viewpoint of flatness of the film surface, input and output performance, and ensuring functions at high temperature.

The HRL 32 preferably contains an additive material such as a binding material from the viewpoint of the retaining property on the base material layer 31. The HRL 32 is generally formed by dispersing an inorganic filler and an additive material into a solvent to prepare a paste, applying the paste onto the base material layer 31, and drying the paste. The dispersion medium is not particularly limited to, for example, a water-based solvent or an organic solvent, but it is preferable to use a water-based solvent in consideration of the costs and the handling property. As an additive material in using a water-based solvent, a polymer capable of being dispersed or dissolved into the water-based solvent may be used. For example, styrene-butadiene rubber (SBR), a polyolefin-based resin such as polyethylene (PE), a cellulose-based polymer such as carboxymethyl cellulose (CMC), a fluororesin such as polyvinyl alcohol (PVA), or a polyalkylene oxide such as polyethylene oxide (PEO) may be used. Moreover, an acrylic resin such as a homopolymer obtained by polymerization of one kind of a monomer selected from among acrylic acid, methacrylic acid, acrylamide, methacrylamide, 2-hydroxyethyl acrylate, 2-hydroxyethyl methacrylate, methyl methacrylate, 2-ethylhexyl acrylate, and butyl acrylate may be raised as an example. The additive material may be a copolymer obtained by polymerization of two or more kinds of the monomers. Further, the additive material may be a mixture of two or more kinds of the homopolymers and copolymers.

The percentage of the inorganic filler in the whole HRL 32 is not particularly limited, but the percentage is preferably not less than 90 mass %, typically not less than 95 mass %, from the viewpoint of ensuring functions at high temperature.

The HRL 32 may be formed, for example, by the following method.

First, the inorganic filler and the additive material mentioned above are dispersed into a dispersion medium to prepare a paste. For the preparation of the paste, a kneader such as a Dispermill (registered trademark), a Clearmix (registered trademark), a Filmix (registered trademark), a ball mill, a homodisper, or an ultrasonic dispersing machine may be used. The obtained paste is applied onto the surface of the base material layer 31 by means of an applying apparatus such as a gravure coater, a slit coater, a die coater, a Comma Coater (registered trademark), or a dip coater, followed by drying the paste to form the HRL 32. The temperature at the time of drying is preferably equal to or lower than a temperature at which shrinkage of the separator 30 occurs (e.g., 110° C. or lower).

### [Non-Aqueous Electrolyte Solution]

As a non-aqueous solvent and an electrolyte salt constituting the electrolyte solution to be poured into the lithium-ion secondary battery 100, those used in a conventional lithium-ion secondary battery may be used without any particular limitation. Examples of the above-mentioned non-aqueous solvent include ethylene carbonate (EC), propylene carbonate (PC), diethyl carbonate (DEC), dimethyl carbonate (DMC), ethyl methyl carbonate (EMC), 1,2-dimethoxyethane, 1,2-diethoxyethane, tetrahydrofuran, 2-methyltetrahydrofuran, dioxane, 1,3-dioxolane, diethylene glycol dimethyl ether, ethylene glycol dimethyl ether, acetonitrile, propionitrile, nitromethane, N,N-dimethylformamide, dimethyl sulfoxide, sulfolane, and y-butyrolactone, and one kind alone or a mixture of two or more kinds selected from among these may be used. In particular, it is preferable to use a mixed solvent of ethylene carbonate (EC), dimethyl carbonate (DMC), and ethyl methyl carbonate (EMC).

As the above-mentioned electrolyte salt, for example, one kind or two or more kinds selected from lithium compounds (lithium salts) such as LiPF₆, LiBF₄, LiClO₄, LiAsF₆, LiCF₃SO₃, LiC₄F₉SO₃, LiN(CF₃SO₂)₂, LiC(CF₃SO₂)₃, and LiI may be used. The concentration of the electrolyte salt is not particularly limited, but the concentration typically may be 0.8 mol/L to 1.5 mol/L.

The above-mentioned non-aqueous electrolyte solution contains an oxalatoborate-type compound and a difluorophosphate compound as additive agents. The oxalatoborate-type compound and the difluorophosphate compound each may be one partly or wholly decomposed.

### [Oxalatoborate-Type Compound]

The oxalatoborate-type compound is represented by the formula (I) in the following chemical formula 1 or by the formula (II) in the following chemical formula 2.

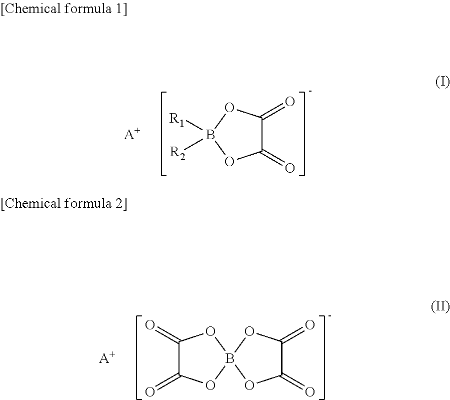

R₁ and R₂ in the formula (I) are selected from halogen atoms (for example, F, Cl, Br, preferably F) and perfluoroalkyl groups having a carbon atom number of 1 to 10 (preferably 1 to 3). A⁺ in the formulas (I) and (II) may be either an inorganic cation or an organic cation.

As the oxalatoborate-type compound, compounds represented by the above-mentioned formula (II) may be preferably used. Among these, lithium bis(oxalato)borate (hereafter denoted as “LiBOB”) represented by the formula (III) in the following chemical formula 3 is more preferably used as the oxalatoborate-type compound.

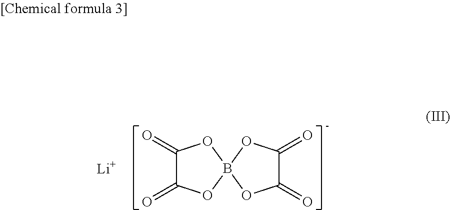

### [Difluorophosphate Compound]

The difluorophosphate compound may be one of various kinds of salts having a difluorophosphate anion (PO₂F₂⁻). A cation (counter cation) in such a difluorophosphate compound may be either an inorganic cation or an organic cation. Specific examples of the inorganic cation include cations of alkali metals such as Li, Na, and K and cations of alkaline earth metals such as Be, Mg, and Ca. Specific examples of the organic cation include ammonium cations such as tetraalkylammonium and trialkylammonium. Such a difluorophosphate compound may be prepared by a known method or is commercially available by purchasing a marketed product. Typically, a salt of a difluorophosphate anion and an inorganic cation (for example, a cation of alkali metal) is preferably used as the difluorophosphate compound. One suitable example of the difluorophosphate compound in the technique disclosed herein is lithium difluorophosphate (LiPO₂F₂).

The lithium-ion secondary battery 100 having such a configuration is excellent both in the input and output characteristics and in the thermal stability at the time of overcharging, and hence may suitably be used as a power source (typically, an assembled battery formed by connection of a plurality of batteries in series) for a driving source of a driving motor or the like of a vehicle equipped with an electric motor, such as in particular a hybrid vehicle (HV), plug-in hybrid vehicle (PHV), an electric vehicle (EV), or a fuel cell vehicle.

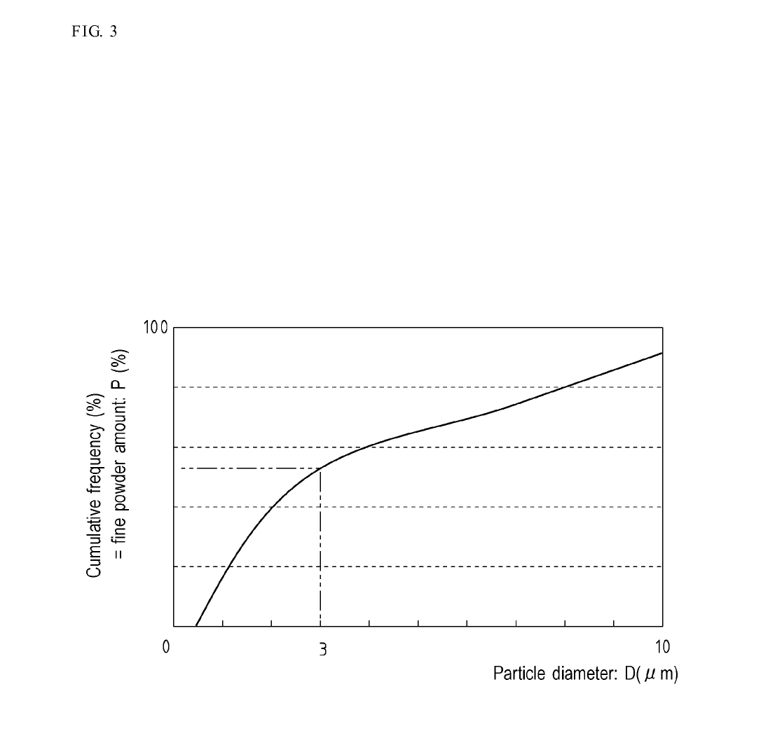

With reference to FIG. 3, the fine powder amount P is described.

In FIG. 3, the lateral axis represents the particle diameter D of a negative electrode active material, and the longitudinal axis represents the cumulative frequency of the amount of the negative electrode active material having a particle diameter not greater than D relative to the total amount of the negative electrode active material.

As shown in FIG. 3, the particle diameter D of the negative electrode active material shows an ununiform variation between 0 μm and 10 μm. The negative electrode active material having a particle diameter D not larger than 3 μm is referred to as the fine powder, and the cumulative frequency of the negative electrode active material having a particle diameter D not larger than 3 μm is defined as the fine powder amount P. In other words, when the fine powder amount P is 15%, it means that the cumulative frequency of the negative electrode active material having a particle diameter D not larger than 3 μm is 15%. With respect to the particle diameter D of the negative electrode active material in the present embodiment, the average particle diameter Dm (particle diameter D50) is set to be not smaller than 5 μm and not larger than 20 μm or less.

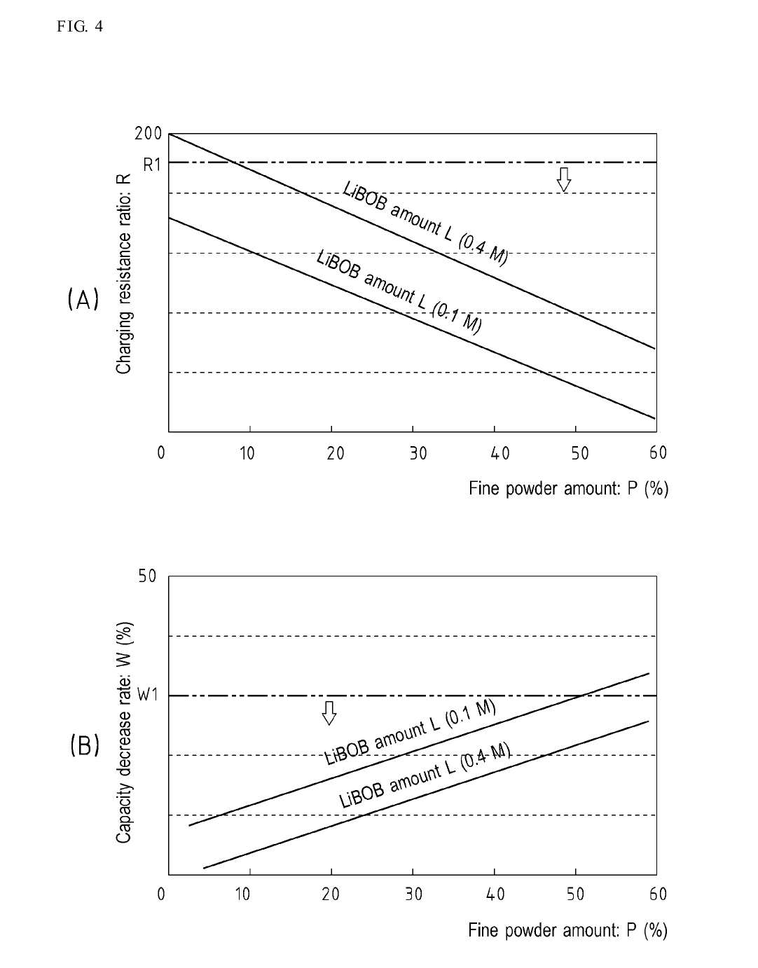

With reference to FIG. 4, the characteristics of the fine powder amount P and the LiBOB amount L is described.

The LiBOB amount L is a concentration of LiBOB in the electrolyte solution.

In FIG. 4(A), the lateral axis represents the fine powder amount P of the negative electrode active material, and the longitudinal axis represents the charging resistance ratio R showing the input characteristics of the lithium-ion secondary battery 100, thereby showing a relationship between the fine powder amount P and the input characteristics.

The relationship between the fine powder amount P and the charging resistance ratio R is shown for a plurality of lithium-ion secondary batteries 100 each having a different LiBOB amount L. Specifically, FIG. 4(A) shows a case in which LiBOB is added so that the LiBOB amount L has a concentration of 0.4 M and a case in which LiBOB is added so that the LiBOB amount L has a concentration of 0.1 M.

The charging resistance ratio R is defined as follows. Assuming that the charging resistance value of the lithium-ion secondary battery 100 with respect to a certain fine powder amount P is 100, the charging resistance ratio R shows a value of the charging resistance with respect to another fine powder amount P. In other words, the charging resistance ratio R is a value such that the charging resistance with respect to each fine powder amount P is made dimensionless.

Further, in FIG. 4(B), the lateral axis represents the fine powder amount P of the negative electrode active material, and the longitudinal axis represents the capacity decrease rate W showing the storage durability of the lithium-ion secondary battery 100, thereby showing a relationship between the fine powder amount P and the capacity decrease rate W.

The capacity decrease rate W is an index showing how much the capacity has decreased after the lithium-ion secondary battery is charged under predetermined conditions and then left to stand for a predetermined period of time.

The relationship between the fine powder amount P and the capacity decrease rate W is shown for a plurality of lithium-ion secondary batteries 100 each having a different LiBOB amount L. Specifically, FIG. 4(B) shows a case in which LiBOB is added so that the LiBOB amount L has a concentration of 0.4 M and a case in which LiBOB is added so that the LiBOB amount L has a concentration of 0.1 M.

As shown in FIG. 4(A), there is a correlation between the fine powder amount P of the negative electrode active material and the charging resistance ratio R. It has been found out that, according as the fine powder amount P increases, the charging resistance ratio R decreases. The reason therefor is as follows. In a negative electrode having a smaller amount of fine powder, since the gap between the negative electrode active materials in the negative electrode mixture layer is larger, the electric conductivity decreases. In contrast, in a negative electrode having a larger amount of fine powder, since the fine powder goes into the gap between the negative electrode active materials having a comparatively large particle diameter D, the electric conductivity rises.

In this manner, according as the fine powder amount P of the negative electrode active material increases, the charging resistance ratio R decreases, and thereby the input characteristics of the lithium-ion secondary battery 100 is improved. Therefore, the larger the fine powder amount P is, the more preferable it is from the viewpoint of improving the input characteristics.

However, as shown in FIG. 4(B), there is a correlation between the fine powder amount P of the negative electrode active material and the capacity decrease rate W. It has been found out that, according as the fine powder amount P increases, the capacity decrease rate W increases. In this manner, according as the fine powder amount P of the negative electrode active material increases, the capacity decrease rate W increases. Therefore, from the viewpoint of improving the capacity decrease rate W, it is not preferable that the fine powder amount P of the negative electrode active material is excessive.

On the other hand, as shown in FIG. 4(B), there is a correlation between the LiBOB amount L and the capacity decrease rate W. It has been found out that, according as the LiBOB amount L increases, the capacity decrease rate W decreases. In this manner, by increasing the amount of LiBOB added into the electrolyte solution, the capacity decrease rate W can be reduced. Therefore, from the viewpoint of reducing the capacity decrease rate W, it is preferable to increase the LiBOB amount L.

However, as shown in FIG. 4(A), there is a correlation between the LiBOB amount L and the charging resistance ratio R. It has been found out that, according as the LiBOB amount L increases, the charging resistance ratio R increases. In this manner, by increasing the amount of LiBOB added into the electrolyte solution, the charging resistance ratio R increases. Therefore, the smaller the LiBOB amount L is, the more preferable it is from the viewpoint of improving the input characteristics.

The fine powder amount P of the negative electrode active material and the LiBOB amount L of the electrolyte solution have such characteristics. Therefore, both of the standards for input characteristics and storage durability of the lithium-ion secondary battery 100 are satisfied when the criteria (determination conditions for satisfying the standard) of the charging resistance ratio R showing the input characteristics of the lithium-ion secondary battery 100 is set to be not larger than R1 (See FIG. 4(A)), and the criteria of the capacity decrease rate W showing the storage durability of the lithium-ion secondary battery 100 is set to be not larger than W1 (See FIG. 4(B)). For this reason, the fine powder amount P of the negative electrode active material and the LiBOB amount L of the electrolyte solution are preferably set to have values within the ranges as mentioned below.

In other words, the fine powder amount P is set to be not less than 10% and not more than 50%. Similarly, the LiBOB amount L is set to be a concentration of not less than 0.1 M and not more than 0.4 M. Specifically, in an initial step of manufacturing the lithium-ion secondary battery 100, LiBOB is added into the electrolyte solution so that the LiBOB amount L may become not less than 0.1 M and not more than 0.4 M.

It has been found out that a negative electrode active material having a fine powder amount P of not less than 10% and not more than 50% has a specific surface area of 2.0 to 5.0 m²/g as measured by the Kr gas adsorption method. The Kr gas adsorption method is a technique of allowing the molecules (Kr) having a known occupying area to be adsorbed onto the surface of powder particles and determining the specific surface area of the sample powder from the adsorption amount thereof. Moreover, the specific surface area refers to the total sum of the surface areas of all the particles present in the powder of unit mass.

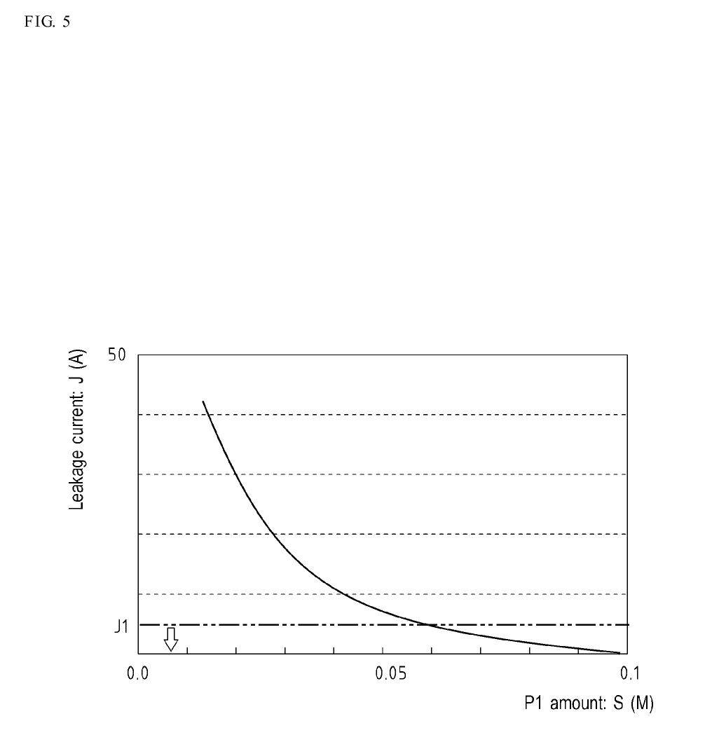

With reference to FIG. 5, the characteristics of the difluorophosphate compound (P1) is described.

In FIG. 5, the lateral axis represents a P1 amount S which is an amount of P1 (concentration of P1) when the fine powder amount P is 50%, and the longitudinal axis represents a leakage current J showing the safety of the lithium-ion secondary battery 100, thereby showing a relationship between the P1 amount S and the safety.

As shown in FIG. 5, it has been found out that there is a correlation between the P1 amount S of the electrolyte and the leakage current J. When the criteria (determination conditions for satisfying the standard) of the leakage current J is not greater than J1, it is demanded that the P1 amount S is not less than 0.06 M.

By considering the above and the criteria of the safety, the P1 amount S of the electrolyte solution in the present embodiment is set to be not less than 0.06 M. In other words, in an initial step of manufacturing the lithium-ion secondary battery 100, P1 is added into the electrolyte solution so that the P1 amount S is not less than 0.06 M.

The advantageous effects of the lithium-ion secondary battery 100 are described. The lithium-ion secondary battery 100 makes it possible to satisfy the standards for input characteristics, storage durability, and safety in a well-balanced manner.

In other words, there is a correlation between the fine powder amount P of the negative electrode active material and the charging resistance ratio R, and there is a correlation between the fine powder amount P and the capacity decrease rate W. Therefore, satisfactory input characteristics and storage durability can be made compatible with each other by defining the fine powder amount P that satisfies the criteria of the charging resistance ratio R which is an index of the input characteristics and the capacity decrease rate W which is an index of the storage durability.

Moreover, there is a correlation between the LiBOB amount L which is an amount of LiBOB constituting an additive agent of the electrolyte solution and the charging resistance ratio R, and there is a correlation between the LiBOB amount L and the capacity decrease rate W. Therefore, satisfactory input characteristics and storage durability can be made compatible with each other by defining the LiBOB amount L that satisfies the criteria of the charging resistance ratio R which is an index of the input characteristics and the capacity decrease rate W which is an index of the storage durability.

Furthermore, there is a correlation between the P1 amount S which is an amount of P1 constituting an additive agent of the electrolyte solution and the leakage current E. Therefore, the safety can be ensured by defining the P1 amount S that satisfies the criteria of the leakage current E which is an index of the safety.

Non-aqueous electrolyte secondary batteries were produced as shown in Examples and Comparative Examples in Table 1 shown below to evaluate the performance of each of the non-aqueous electrolyte secondary batteries.

### [Production of Positive Electrode]

A mixed liquid of nickel sulfate, cobalt sulfate, and manganese sulfate solutions was neutralized with sodium hydroxide to prepare a precursor containing Ni_{0.34}Co_{0.33}Mn_{0.33}(OH)₂ as a basic structure. The obtained precursor was mixed with lithium carbonate and firing was arbitrarily carried out at 800 to 950° C. for 5 to 15 hours in an air atmosphere to prepare Li_{1.14}Ni_{0.34}Co_{0.33}Mm_{0.33}O₂ as a positive electrode active material. This positive electrode active material was subjected to adjustment so that the particle diameter D50 would be 3 to 8 μm and the specific surface area would be 0.5 to 1.9 m²/g.

The above-mentioned positive electrode active material, AB (conductive material), and PVDF (binding material) were mixed with NMP (dispersion medium) so that the mass ratio of these materials would be 90:8:2 to prepare a positive electrode mixture. This positive electrode mixture was applied onto both the surfaces of an aluminum foil (collecting foil) having a thickness of 15 μm. Adjustment was made so that the application amount of the positive electrode mixture onto both the surfaces would be approximately 11.3 mg/cm² (after drying, in a solid component standard). After the applied positive electrode mixture was dried, the resultant was pressed by a rolling pressing machine to adjust the density of the positive electrode mixture layer to 1.8 to 2.4 g/cm³. The obtained electrode was slit to produce a band-shaped positive electrode having a length of 3000 mm and a width of 98 mm.

### [Production of Negative Electrode]

With use of an air classification machine, the particle size of natural graphite powder was adjusted to obtain natural graphite powder having different particle sizes. The obtained natural graphite powder was mixed with pitch (mass ratio of natural graphite powder to pitch=96:4), and the obtained mixture was fired at 800 to 1300° C. for 10 hours in a nitrogen atmosphere. Through the above-mentioned steps, negative electrode active materials having different fine powder amounts and different surface areas were obtained. This negative electrode active material, SBR, and CMC were mixed at a weight ratio of 97.0:1.5:1.5 with ion-exchange water, and shear was applied with use of a planetary mixer to prepare a negative electrode mixture. This negative electrode mixture was applied onto both the surfaces of a copper foil having a thickness of 10 μm. Adjustment was made so that the application amount of the negative electrode mixture onto both the surfaces would be approximately 7.0 mg/cm² (after drying, in a solid component standard). After the applied negative electrode mixture was dried, the resultant was pressed by a rolling pressing machine to adjust the density of the negative electrode mixture layer to approximately 0.9 g/cm³ to 1.3 g/cm³. The obtained electrode was slit to produce a band-shaped negative electrode having a length of 3200 mm and a width of 102 mm.

### [Production of Heat-Resistant Separator]

A paste was prepared by kneading alumina powder (Al₂O₃) as an inorganic filler, an acrylic binder, and CMC as a thickening agent together with ion-exchange water as a solvent so that the blending ratio of Al₂O₃:binder:CMC would be 98:1.3:0.7. This paste was applied onto one surface of a monolayer porous sheet made of polyethylene and having a thickness of 20 μm, and was dried at 70° C. to form an inorganic porous layer (heat-resistant layer), thereby to obtain a heat-resistant separator. The application amount (coating amount) of the above-mentioned paste was adjusted to 0.7 mg/cm² in a solid component standard.

### [Preparation of Electrolyte Solution]

The electrolyte solution was prepared by dissolving 1.1 mol/L of LiPF₆ into a mixture obtained by mixing ethylene carbonate (EC), ethyl methyl carbonate (EMC), and dimethyl carbonate (DMC) at a ratio of 3:3:4 and further dissolving lithium bis(oxalato)borate (LiBOB) and lithium difluorophosphate (LiPO₂F₂) as additive agents.

### [Production of Cell]

The above-mentioned positive electrode and negative electrode were superposed with two sheets of the above-mentioned heat-resistant separators interposed therebetween to produce a wound electrode body having a flat shape.

This wound electrode body was airtightly housed together with the electrolyte solution in a battery case formed in a box.

With respect to the battery cell produced as mentioned above, cell evaluation was carried out after initial charge and discharge.

### [Particle Size Distribution Measurement Method]

The fine powder amount was measured by using a flow-type particle image analyzing apparatus (manufactured by Sysmex Corporation: FPIA (registered trademark)-3000). The dispersion conditions were such that the dispersion was carried out at an agitation speed of 300 rpm using RO water and a surfactant (Naroacty (registered trademark)).

### [Leakage Current Measurement Method]

The cell was adjusted so as to have SOC of 30% at −10° C., and charging was carried out at an electric current value of 40 A. The maximum electric current value 10 minutes after the separator base material shut down was measured.

TABLE 1

| | | | | | | Comparative | Comparative | Comparative | Comparative | Comparative |
|---|---|---|---|---|---|---|---|---|---|---|
| | | Example | Example | Example | Example | Example | Example | Example | Example | Example |
| Electrolyte | LIBOB (M) | 0.4 | 0.4 | 0.1 | 0.1 | 0.1 | 0.05 | 0.45 | 0.1 | 0.4 |
| solution | P1 (M) | 0.06 | 0.06 | 0.06 | 0.06 | 0.05 | 0.06 | 0 | 0.06 | 0.06 |
| Negative | Fine powder | 10.2 | 49.3 | 10.2 | 49.3 | 49.3 | 49.3 | 10.2 | 52.1 | 5.2 |
| electrode | (cumulative % | | | | | | | | | |
| active | of not greater | | | | | | | | | |
| material | than μm) | | | | | | | | | |
| | KrBET (m2/g) | 2.0 | 5.0 | 2.0 | 5.0 | 5.0 | 5.0 | 2.0 | 5.3 | 1.5 |
| Cell | % | 178.2 | 48.0 | 120.2 | 38.4 | 39.4 | 38.2 | 192.1 | 30.2 | 192.5 |
| evaluation | | | | | | | | | | |
| (input ratio) | | | | | | | | | | |
| Capacity | % | 4.7 | 17.3 | 10.2 | 28.3 | 26.3 | 35.2 | 4.5 | 40.3 | 2.1 |
| decrease | | | | | | | | | | |
| ratio | | | | | | | | | | |
| Cell | Leakage | 0.4 | 0.7 | 0.4 | 0.5 | 5.1 | 0.4 | 8.1 | 8.0 | 0.5 |
| evaluation | current | | | | | | | | | |
| (continuous | amount (A) | | | | | | | | | |
| energization) | | | | | | | | | | |
| Judgment | | ∘ | ∘ | ∘ | ∘ | x | x | x | x | x |

### INDUSTRIAL APPLICABILITY

The present invention can be used for a non-aqueous electrolyte secondary battery and a method for manufacturing a non-aqueous electrolyte secondary battery.

### REFERENCE SIGNS LIST

10: Positive electrode

11: Metal foil

12: Positive electrode mixture layer

20: Negative electrode

21: Metal foil

22: Negative electrode mixture layer

30: Separator

55: Wound electrode body

100: Lithium-ion secondary battery

1. A non-aqueous electrolyte secondary battery comprising:
a wound electrode body formed by winding a positive electrode and a negative electrode with a separator interposed therebetween; and
an electrolyte solution provided between the positive electrode and the negative electrode,
wherein a negative electrode mixture layer containing a negative electrode active material is formed on a surface of the negative electrode,
wherein an average particle diameter of the negative electrode active material is not smaller than 5 μm and not larger than 20 μm,
wherein a fine powder amount which is the cumulative frequency of the negative electrode active material having a particle diameter not larger than 3 μm is not less than 10% and not more than 50%, and
wherein the electrolyte solution contains not less than 0.1 M and not more than 0.4 M of an oxalatoborate-type compound, and not less than 0.06 M of a difluorophosphate compound.

2. A method for manufacturing a non-aqueous electrolyte secondary battery having a wound electrode body formed by winding a positive electrode and a negative electrode with a separator interposed therebetween, and an electrolyte solution provided between the positive electrode and the negative electrode, comprising:
a step for forming a negative electrode mixture layer containing a negative electrode active material on a surface of the negative electrode,
a step for adjusting an average particle diameter of the negative electrode active material to not smaller than 5 μm and not larger than 20 μm,
a step for adjusting a fine powder amount which is the cumulative frequency of the negative electrode active material having a particle diameter not larger than 3 μm to not less than 10% and not more than 50%, and
a step for adding not less than 0.1 M and not more than 0.4 M of an oxalatoborate-type compound, and not less than 0.06 M of a difluorophosphate compound into the electrolyte solution.
